(19) United States
(12) Patent Application Publication
(10) Pub. No.: US 2002/0133575 A1
(43) Pub. Date: Sep. 19, 2002

(54) Troubleshooting remote internet users

(75) Inventors: Israel Cidon, Haifa (IL); Lior Horn, Yokneam Illit (IL); Oren Yabo, Pardes Hana (IL)

Correspondence Address: LADAS & PARRY, 26 WEST 61ST STREET, NEW YORK, NY, 10023, US

(73) Assignee: VIOLA NETWORKS LTD.

(21) Appl. No.: 10/079,821

(22) Filed: Feb. 20, 2002

Related U.S. Application Data
(60) Provisional application No. 60/270,212, filed on Feb. 22, 2001.

(51) Int. Cl. G06F 15/173; G06F 15/16; G06F 15/177

(52) U.S. Cl. 709/220; 709/217; 709/224

(57) ABSTRACT

A method for network service diagnostics includes receiving a request from a user of a computer for assistance in an activity performed by the computer. Responsive to the request, an executable program module is downloaded to the computer over a communication network, which module, when run by the computer, causes the computer to perform a diagnostic operation including sending one or more messages over the network. The messages sent by the computer while the computer is running the module are received and processed, in order to extract diagnostic information from the messages so as to diagnose a problem in the activity performed by the computer.

### CROSS-REFERENCE TO RELATED APPLICATION

This application claims the benefit of U.S. Provisional Patent Application No. 60/270,212, filed Feb. 22, 2001, which is incorporated herein by reference.

### FIELD OF THE INVENTION

The present invention relates generally to network-based computer applications, and specifically to testing and fault discovery in such applications.

### BACKGROUND OF THE INVENTION

When a computer user encounters a problem in operation of a network-based application, finding the source of the problem can be extremely difficult. The user's computer is typically connected to the Internet via some remote access method, such as a dialup line, ISDN, DSL, cable modem or wireless connection, to a local Internet Service Provider (ISP). This service provider is typically connected to one or more Internet backbone providers. The local ISP or user typically uses access services such as access routing, firewalls, Web caching, DHCP, DNS service and mobility management. The problem encountered by the user may reside in any of these elements, or it may actually be a problem in the user's computer, in the core network, or at the side of the Application Service Provider (ASP). (In the context of the present patent application and in the claims, the term ASP is used to refer generally to entities that operate network servers offering content or other services to users.)

The picture on the ASP side is even more complex than on the user side. In addition to Internet access facilities, the ASP may have a complex scalability and security infrastructure. It may relocate and maintain geographically-duplicated sites, or use third-party content-delivery services. The ASP may maintain reverse proxies and complex firewall structures. It may have different type of servers (such as database, application and Web servers), and it may replicate the servers within each site and perform load balancing among them.

In addition to the complex Internet infrastructure, the application software itself typically has many components, as well as various user levels and profiles. It may have customization features, making it unique to each customer or customer group. The application typically operates over a Web browser, which may be enhanced with optional code such as browser plug-ins, Java™ applets and JavaScript. Such value-added code may make wrong assumptions about the user's runtime environment and available computation, communication and visualization resources.

Thus, there is clearly a need for diagnostic tools that can be used to quickly and precisely determine the source of a problem encountered by a user in a network application. Since the user's complaints are most often directed at the ASP (not always with justification), it is desirable that the tools be conveniently accessible to the ASP.

Various methods are known in the art for testing network performance and localizing problems in the network. For example, U.S. Pat. No. 5,812,529, whose disclosure is incorporated herein by reference, describes a system and method for acquiring network performance data, built around a “mission server,” which interfaces with clients to receive requests for “missions.” A typical mission includes operations such as transmission and reception of data packets among devices connected to segments of the network. The mission is performed and/or supported by “sentries,” typically software agents running on stand-alone network devices or end-points. The sentries carry out mission operations in response to commands from the mission server, and report back to the mission server on the mission results.

U.S. Pat. Nos. 5,838,919 and 5,881,237, whose disclosures are incorporated herein by reference, describe methods, systems and computer program products for testing of network performance using test scenarios that simulate actual communications traffic between network endpoints. Specific test protocols are assigned to endpoint nodes on the network. Typically, the nodes are paired, and one of the nodes in the pair communicates the protocol to the other, associated node. A console node sets up the test protocols, initiates their execution and receives data on the test performance from the endpoint nodes.

U.S. Pat. No. 6,269,330, whose disclosure is incorporated herein by reference, describes a method and apparatus for testing a network having a plurality of nodes. The method includes sending commands to one or more traffic agents connected to the network and to at least one network management agent coupled to a respective node of the network, transmitting data from at least one of the traffic agents over the network responsive to the commands, determining network information at the at least one network management agent responsive to the commands and to transmission of the data through the respective node, and receiving and evaluating the network information to assess a state of the network.

Aspects of the methods described in U.S. Pat. No. 6,269,330 are embodied in an Active Testing Framework (ATF) known as NetAlly, available from Viola Networks (formerly omegon), of Yokneam, Israel. NetAlly integrates the following components:

Test Center—orchestrates all NetAlly components to render network tests at scheduled or event-triggered times, or interactively. In addition, it generates reports and triggers alerts when faults are detected.

Test Directory—contains a set of predefined tests that can be parameterized manually or automatically.

Traffic Agents—located at network junctions and end-points. Agents are controlled by the Test Center and can inject traffic that follows specific patterns into the network, simultaneously intercept traffic from the network and other Traffic Agents, and then report back to the Test Center. Agents can be installed as software agents on workstations or servers. They can also take the form of dedicated hardware probes or be built into network communication equipment.

Network Interfaces—NetAlly leverages existing network management technology, including SNMP, RMON and telnet-based device access, to obtain monitored network data and for configuration of active testing.

The ATF test directory includes tests that can be used for various forms of network testing and diagnosis. Some of these tests emulate different types and classes of traffic between users or between users and application servers. Such tests measure the network performance in terms of loss, jitter, throughput, round-trip delay, out-of-order packets or other factors. Some tests use standard network management interfaces, such as RMON to read applicable attributes from network equipment and conduct real-time correlation between the equipment readings and NetAlly test traffic. Other tests check the availability and performance of higher-level network services and protocols, such as electronic mail, Web, DNS, FTP and DHCP. The combination of emulated traffic tests and tests of services can be used to identify whether a problem is due to a network fault or to a server.

Although the NetAlly ATF system offers a comprehensive set of tests and measurements, it lacks the ability to probe the network beyond the organizational boundaries of network service and application providers. For users who are not under the control of such an organization, such as customers accessing an ASP via the Internet, there is no practical way to install hardware or software traffic agents to test problems whose origin may be in the user's computer or at the user end of the communications. Even if such agent could be deployed, its control would have to be transparent to firewalls along the way, thus limiting severely the potential effectiveness of such an agent.

Global Performance Services (GPS) are another emerging method for actively tracking performance of Webbased applications. Current GPS systems include, for example, Keynote Prespective (available from Keynote Systems, San Mateo, Calif.) and Topaz (Mercury Interactive, Sunnyvale, Calif.). GPS providers deploy and operate a large collection of measurement servers (MS) in strategic places in the global Internet, particularly at Network Access Point (NAPs) and at popular Internet Data Centers. When an ASP subscribes to a GPS provider, the GPS measures and reports regularly on the response time and behavior of the ASP when accessed from various places. These operations are coordinated by a central Web site operated by the GPS provider. In other words, the GPS itself acts as an ASP, offering measurements and management applications to other ASPs.

Although GPS can provide useful information to ASPs regarding network and server performance, it still does not address the difficulty noted above in diagnosing problems at the user end of network applications. Current GPS tests are always conducted between measurement servers, which are part of the GPS infrastructure, and the Web server of the ASP. This model is of limited use when a specific user of the ASP encounters difficulties or when a problem occurs in an area are not covered by the GPS. Furthermore, the rigid structure of the GPS setup allows only Web-based applications to be tested.

### SUMMARY OF THE INVENTION

It is an object of some aspects the present invention to provide improved methods and systems for diagnosing problems encountered in computer networks and network applications.

It is a particular object of some aspects of the present invention to provide methods and systems that are capable of diagnosing problems encountered by remote users of network applications.

In preferred embodiments of the present invention, when a user reports a problem in running a computer program, an executable module is downloaded to the user's computer over a network for use in diagnosing the problem. Preferably, the module comprises an applet, which runs on the user's network browser without installation. The module may be downloaded directly to the user from a supplier of the program, or it may alternatively be provided by a third-party test center. This model of interaction is particularly useful in diagnosing problems in a network application used in communicating with an ASP, but may be applied to other types of programs, as well.

The module serves as a provisional traffic agent (PTA) on the user's computer. In this capacity, it can send and receive messages through the network, as well as generating and monitoring activity on the user's computer. The operation of the PTA and its interaction with the ASP and/or test center is similar to that of the NetAlly traffic agents described in the Background of the Invention, except that the PTA requires no installation and is able conveniently to probe the user end of the application and communications chain. The ASP or test center receives and processes the messages and reports sent by the PTA, and uses the information they carry, along with information from other traffic agents and monitoring sites, to diagnose the problem in the activity performed by the computer.

There is therefore provided, in accordance with a preferred embodiment of the present invention, a method for network service diagnostics, including:

receiving a request from a user of a computer for assistance in an activity performed by the computer;

responsive to the request, downloading an executable program module to the computer over a communication network, which module, when run by the computer, causes the computer to perform a diagnostic operation including sending one or more messages over the network; and

receiving and processing the messages sent by the computer while the computer is running the module, in order to extract diagnostic information from the messages so as to diagnose a problem in the activity performed by the computer.

Typically, receiving the request includes receiving a complaint from the user relating to communication over the network, and receiving and processing the messages includes testing the communication so as to determine a source of the problem. Further typically, receiving the complaint includes receiving the complaint at a site operated by a provider of a service over the network, regarding the communication between the user and the site, and testing the communication includes determining whether the source of the problem is within the site.

In a preferred embodiment, downloading the executable program module includes downloading the module from the site operated by the provider of the service to the computer.

In another preferred embodiment, downloading the executable program module includes downloading the module from a third-party site to the computer, and receiving and processing the messages includes receiving the messages at the third-party site, and outputting a report, based on the messages, from the third-party site to the site operated by the provider of the service.

Preferably, determining whether the source of the problem is within the site includes deploying a plurality of traffic agents on different servers at the site, and receiving at least some of the messages sent by the computer at the different servers in order to localize the problem within the site.

When receiving the complaint includes receiving the complaint in connection with a software application that is used in the communication over the network, testing the communication preferably includes determining whether the problem is due to the application or to an element of the communication network.

Additionally or alternatively, the executable program module, when run by the computer, tests an internal function of the computer, and receiving and processing the messages includes receiving information regarding the internal function and determining, responsive to the information, whether the problem is due to the internal function of the computer.

Preferably, downloading the executable program module includes downloading software code capable of running on the computer without installation of the module on the computer. Most preferably, the software code includes an applet, which is configured to run in conjunction with a browser program on the computer.

Preferably, receiving and processing the messages includes receiving one or more of the messages at a traffic agent connected to the network, and informing a test center regarding receipt of the messages. Additionally or alternatively, the method includes transmitting a further message from a traffic agent connected to the network to the computer while the computer is running the module, and informing a test center regarding receipt of the messages by the computer.

Further preferably, receiving and processing the messages includes receiving one or more of the messages at a test center, wherein the one or more of the messages contain a report of the diagnostic operation performed by the computer.

There is also provided, in accordance with a preferred embodiment of the present invention, a method for computer diagnostics, including:

receiving a request from a user of a computer to a helpdesk operated by a supplier of a network service, for assistance in solving a problem encountered by the user in operation of the service;

reporting the request from the helpdesk to a test center;

responsive to the request, downloading an executable program module from the test center to the computer over a communication network, which module, when run by the computer, causes the computer to perform diagnostic operations including communicating over the network; and

exchanging messages between the test center and the computer while the computer is running the module, so as to select the diagnostic operations to be performed by the computer and to receive information from the computer regarding a result of the operations;

responsive to the information received from the computer, providing a report from the test center to the helpdesk indicative of a source of the problem.

Preferably, downloading the executable program module includes downloading software code capable of running on the computer without installation of the module on the computer. Further preferably, the software code is configured to run in conjunction with a browser program on the computer. Most preferably, the software code includes an applet.

In a preferred embodiment, exchanging the messages includes exchanging the messages in accordance with a Hypertext Transfer Protocol (HTTP), such that the test center acts as a HTTP server, while the computer acts as a HTTP client.

There is additionally provided, in accordance with a preferred embodiment of the present invention, apparatus for computer diagnostics, including a test server, which is adapted to receive a report of a request from a user of a computer for assistance in an activity performed by the computer and, responsive to the request, to cause an executable program module to be downloaded to the computer over a communication network, which module, when run by the computer, causes the computer to perform a diagnostic operation including sending one or more messages over the network, and which is further adapted to receive and process at least some of the messages sent by the computer while the computer is running the module, in order to diagnose a problem in the activity performed by the computer.

There is further provided, in accordance with a preferred embodiment of the present invention, apparatus for computer diagnostics, including:

a helpdesk server, which is adapted to receive an indication from a helpdesk operated by a supplier of a network service of a request from a user of a computer for assistance in solving a problem encountered by the user in operation of the service;

a test agent download server, which is adapted, responsive to the request, to download an executable program module to the computer over a communication network, which module, when run by the computer, causes the computer to perform diagnostic operations including communicating over the network; and

a test server, which is adapted to exchange messages with the computer while the computer is running the module, so as to select the diagnostic operations to be performed by the computer and to receive information from the computer regarding a result of the operations,

wherein responsive to the information received from the computer, the helpdesk server provides a report to the helpdesk indicative of a source of the problem.

There is moreover provided, in accordance with a preferred embodiment of the present invention, a computer software product, including a computer-readable medium in which program instructions are stored, which instructions, when read by a computer server, cause the server, responsive to receiving a report of a request from a user of a client computer for assistance in an activity performed by the client computer, to cause an executable program module to be downloaded to the client computer over a communication network, which module, when run by the client computer, causes the client computer to perform a diagnostic operation including sending one or more messages over the network, the instructions further causing the server to receive and process at least some of the messages sent by the client computer while the client computer is running the module, in order to diagnose a problem in the activity performed by the client computer.

There is furthermore provided, in accordance with a preferred embodiment of the present invention, a computer software product, including a computer-readable medium in which program instructions are stored, which instructions, when read by a set of one of more computer servers, cause the servers to receive an indication, from a helpdesk operated by a supplier of a network service, of a request from a user of a client computer for assistance in solving a problem encountered by the user in operation of the service, and further cause the servers, responsive to the request, to download an executable program module to the client computer over a communication network, which module, when run by the client computer, causes the computer to perform diagnostic operations including communicating over the network, and further cause the servers to exchange messages with the client computer while the client computer is running the module, so as to select the diagnostic operations to be performed by the client computer and to receive information from the client computer regarding a result of the operations, and responsive to the information received from the client computer, to provide a report to the helpdesk indicative of a source of the problem.

The present invention will be more fully understood from the following detailed description of the preferred embodiments thereof, taken together with the drawings in which:

### BRIEF DESCRIPTION OF THE DRAWINGS

FIG. 1 is a block diagram that schematically illustrates a system for troubleshooting a user computer over the Internet, in accordance with a preferred embodiment of the present invention;

FIG. 2 is a flow chart that schematically illustrates a method for remote troubleshooting, in accordance with a preferred embodiment of the present invention;

FIG. 3 is a block diagram that schematically illustrates a system architecture for providing remote troubleshooting services, in accordance with a preferred embodiment of the present invention; and

FIG. 4 is a block diagram that schematically illustrates operation of a system for troubleshooting a user computer over the Internet in the presence of firewalls, in accordance with a preferred embodiment of the present invention.

### DETAILED DESCRIPTION OF PREFERRED EMBODIMENTS

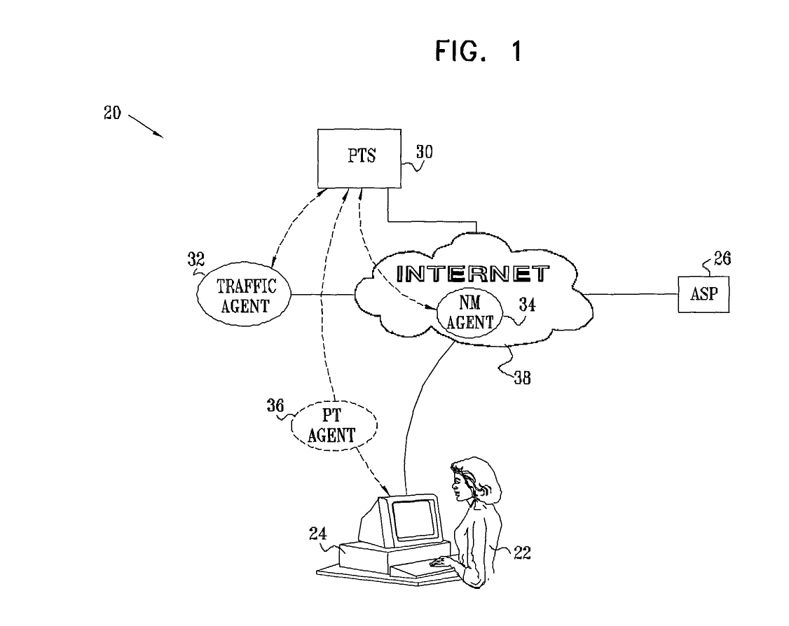

FIG. 1 is a block diagram that schematically illustrates a system 20 for remote troubleshooting of difficulties encountered by a user 22, operating a user computer 24, in accordance with a preferred embodiment of the present invention. In the embodiment shown here, it is assumed that the user encounters a connectivity, performance or application problem in interacting with a provider of services or content, referred to here as an ASP 26, with which the user communicates via a network 38, such as the Internet.

Troubleshooting services are provided by a provisional test service (PTS) 30, which typically contracts with ASP 26 to assist in diagnosis of user difficulties. PTS 30 operates in a manner similar to the NetAlly system described in the Background of the Invention, using a set of traffic agents 32 and network management agents 34 that are permanently deployed in and around network 38 for use in network testing and diagnosis. Although traffic agents 32 may be permanently installed in software at various network endpoint computers (including servers operated by ASP 26), it is assumed that there is no such software installed on user computer 24.

Therefore, when user 22 reports to ASP 26 that she has encountered a problem in her interaction with the ASP, a provisional traffic agent (PTA) 36 is downloaded over network 38 from PTS 30 to computer 24 for use in diagnosing the problem. PTA 36 is a traffic agent that is packaged as an executable module, which preferably runs on computer 24 without installation. Most preferably, PTA 36 is an applet, which runs on the user's browser software, using the existing Java Virtual Machine (JVM) provided by the browser. Alternatively, other types of executable modules may be used for this purpose, such as an ActiveX™ module. The module is preferably certified by PTS 30, using methods of digital certification known in the art, so that the browser will allow the applet to act as a fully-functioning traffic agent. Preferably, PTA 36 runs on computer 24 in background, so that the user can continue to use the computer for other purposes while the PTS is running.

Although PTS 30 is shown in the figures as a separate entity from ASP 26, at least some of the functions of the PTS may alternatively be carried out by the ASP. Thus, as long as ASP 26 has the required hardware and software resources, PTA 36 may be downloaded to computer 24 directly from the ASP site. The ASP itself may also carry out some or all of the tests described below, at least those tests that involve direct interaction between the user computer and the ASP. The model shown in FIG. 1 is advantageous, however, in that PTS 30 is able to serve a large number of ASPs and perform a wider range of tests than could typically be carried out by a single ASP on its own. PTS 30 has the capabilities and resources needed to deploy permanent agents 32 and 34 around the network, and is better able to identify and localize the cause of difficulties when they occur. Therefore, preferred embodiments of the present invention are described hereinbelow with reference to PTS 30, but it will be understood that the functions of the PTS may also be performed by ASP 26 or by other entities on network 38.

In any case, the solution shown in FIG. 1 enables computer 24 to be equipped with a fully-functional traffic agent, with no need to install any software. This solution is attractive both to end-users within large organizations, in which massive agent distribution is not practical, and to remote users and e-customers in situations in which the user machine, such as computer 24, is not under the administration of the service or communication provider. When PTA 36 finishes its work, it is preferably deleted from computer 24, leaving no trace in user memory or on disk. If it is necessary for PTA 36 to collect or monitor any user activity or transfer any user data, the PTA preferably prompts the user for permission beforehand, in order to ensure that user privacy is maintained. Generally speaking, however, the PTA is used only for operability and performance troubleshooting, so that user information is kept private and secure.

PTA 36 may also be controlled by PTS 30 to report to user 22 regarding the testing results and possible conclusions or further actions. The report may be textual, graphical or multimedia-enriched. For example, the report may suggest to user 22 certain local configuration and/or optimization to be conducted manually or automatically. Alternatively or additionally, PTA 36 may include a resolution part, which takes local corrective action automatically after prompting user 22 for consent.

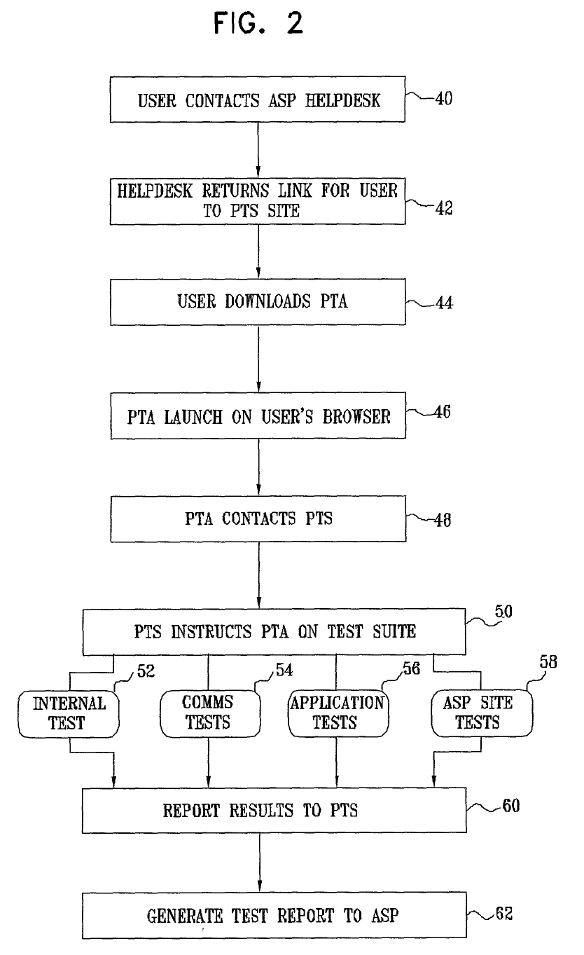

FIG. 2 is a flow chart that schematically illustrates a method for remote troubleshooting using the elements of system 20, in accordance with a preferred embodiment of the present invention. The procedure shown in FIG. 2 is triggered when user 22 contacts the helpdesk at ASP 26 with a complaint about service availability, correctness or performance, or requests customer support for some other reason, at a complaint step 40. Alternatively, the procedure may be initiated by ASP 26 or PTS 30 upon receiving some other indication of user or network difficulties. User 22 is asked to direct her browser to a Uniform Resource Locator (URL) belonging to PTS 30 from which PTA 36 is to be downloaded, at a link direction step 42. For example, the URL may appear as a link on the ASP Web page, or it may be sent by the helpdesk or by PTS 30 to the user by e-mail, or even simply read over the telephone to the user.

User 22 enters the URL in her browser or clicks on the URL link. The user may be required at this point to supply further information, such as a user ID and/or password. PTA 36 is then automatically downloaded to computer 24, at a download step 44. Optionally, PTA 36 is made up of two parts: an agent framework and a test library. The agent framework is responsible for arbitration of communication with PTS 30, and running the tests. It is preferably transient and is downloaded to computer 24 time the PTA is to be launched. The test library (including native test components) may be cached on computer 24 and is version controlled. Thus, it may be downloaded only once to the browser on computer 24 and then retained there. If there is a change in tests, the version is advanced, and the new library is reloaded to PTA 36 from PTS 30

Typically, once PTA 36 is downloaded, it begins running immediately, at a PTA launch step 46, and notifies the user that it was downloaded successfully by presenting a message in a popup window. Alternatively, the window may prompt the user to approve initiation of PTA test operations. The user may then minimize the PTA popup window and continue with other activities. Preferably, the user is able to terminate operation of the PTA at any time, using an appropriate control in the PTA window.

Once the automatic download and launch process is complete, PTA 36 contacts PTS 30 to indicate that it is ready to begin testing, at a PTA contact step 48. PTS 30 begins a series of tests in real time, in conjunction with PTA 36, at a test initiation step 50. The tests send traffic over network 38 directly to and from computer 24, thus providing the PTS operator with a “user perspective” on the reported problem. Typical tests include those that measure and verify the performance of networked servers accessed by the user. For some specialized tests not covered by the basic PTA, PTS 30 may download additional test code (or “testlets”) to the PTA. Communications between PTS 30, PTA 36 and other agents 32 and 34 are preferably conducted in such a way as to pass easily through any firewalls that may intervene. Web protocols such as HTTP and HTTPS, as well as XML instructions, typically work well in this context, but other application ports and protocols may also be configured for this purpose. Preferably, PTS 30 acts as a HTTP server in these communications, while PTA 36 is the HTTP client.

The suite of tests carried out by PTA 36 under the control of PTS 30 preferably includes tests of some or all of the following types:

Internal tests 52 conducted at end-user computer 24. These tests may include information about user configuration, CPU type, memory and disk space, as well as CPU utilization. The tests can include certain benchmark programs (such as a computation or string operation) and measurement of how long they take to complete.

Communication-based tests 54. Several types of such communication tests can be used:

Communication tests against intermediate Internet nodes. These tests can include PING from computer 24 to certain IP addresses, TraceRoute tests, as well as application-based TraceRoute tests. PTA 36 may also perform HTTP downloads against public Web sites, in order to establish a baseline of normal performance by the computer. Other tests may check mechanisms of the Internet Service Provider (ISP) through which computer 24 accesses network 38, including tests of functions such as caching, DNS, DHCP and SMTP.

Communication tests against reference traffic agents 32, which are distributed around network 38. Such tests can mimic applications (such as HTTP, SMTP, VoIP), as well as measuring network performance parameters, such as packet loss, packet fragmentation, delay and jitter, using one-way and/or two-ways tests. Exemplary tests of this sort are described further in U.S. patent application Ser. No. 09/557,256, filed Apr. 24, 2000, and in U.S. patent application Ser. No. 09/587,913, filed Jun. 6, 2000, which are assigned to the assignee of the present patent application, and whose disclosures are incorporated herein by reference.

Communication tests against traffic agents which are positioned at the site of ASP 26. These agents may be positioned both in front of and behind the ASP firewall, and may be located on different strategic subnets in the ASP facility. Tests in this category may include traffic generation and reception using all relevant protocols, optionally at different rates and with different packet sizes. Anomalies in key measurements, such as maximal throughput, loss, delay, jitter and fragmentation, can be observed and compared. Quality of Service (QoS) measurements of different applications can be compared individually or in combination.

Application tests 56 against Web servers and/or other application servers at the site of ASP 26, or at multiple sites.

ASP site tests 58, to evaluate the functionality of special technologies used by the ASP, such as Web load balancing devices and DNS-based redirection mechanisms.

The tests are preferably launched in bundles. They may also include a conditional mechanism, such that a predefined result range of a certain test triggers another test with a given set of parameters. Such tests can be designated and configured from bundles that are provided and downloaded in advance to computer 24. Alternatively, test bundles may include conditional triggers, which cause PTA 36 to communicate with PTS 30 under certain conditions, and lead the PTS to download and invoke additional, optional tests.

During the testing or upon its completion, PTA 36 and any other participating traffic agents 32 and network management agents 34 report their test results to PTS 30, at a result reporting step 60. The PTS processes the results and generates a report, which is passed back to ASP 26, at a test reporting step 62. The PTS typically maps performance problems to one of the following areas:

1. User premises (an individual or organization), including her computing gear (computer 24).

2. User networking (Internet access, CPE router, overloaded connection).

3. The user's ISP or the Internet itself

4. Different components of ASP 26. These may include the networking part (ISP, Content Delivery and Distribution [CDD] provider, firewall, routers, load balancing equipment) or the computing part (servers and applications) of the ASP facilities.

The report at step 62 is typically returned to the helpdesk agent dealing with the matter, either by presenting the results on a secure Web page, or sending the report to the agent by e-mail, or by other means. Selected test results may also be shared with user 22. Based on these results, the helpdesk may be able to direct maintenance personnel of ASP 26 to take corrective action, including remote actions using PTA 36 that is resident on computer 24, or to help user 22 solve a problem on computer 24, or to direct the user to seek assistance from another quarter (such as her ISP).

It may occur that the source of the problem reported by user 22 is not discovered at once, possibly because the problem stems from an intermittent condition. In such a case, with the user's consent, PTA 36 may remain active on computer 24, and the tests may be repeated periodically for several hours or even days. The report generated at step 62 will preferably show the variation in results over time in graphical form. In any case, when testing is completed, PTA 36 is terminated, leaving no trace on computer 24.

As an example of the operation of the method of FIG. 2, assume that user 22 complains about slow response of a Web-based application. In such a case, it is not generally clear whether the problem results from a slow connection, an overloaded proxy cache used by the user, slow DNS resolution, firewall problems or slow Web server response at ASP 26. Therefore, a number of different tests can be used to resolve the problem:

Connection speeds can be tested between PTA 36 and two different traffic agents, one located before the firewall at ASP 26, and the other behind the firewall.

DNS resolution times can be measured by the PTA by running address resolution routines for domain names that are associated with ASP 26.

Proxy cache performance can be measured by triggering a test that downloads artificially-created pages from another traffic agent to the proxy server, so as to measure and compare the proxy performance for cached and uncached data. In this case, PTA 36 first downloads a benchmark page using a provisional URL that contains a unique string that was never downloaded before (for example, some known URL that is extended with a randomly-chosen 64-bit number). This page will not have been cached by the user's organization or ISP. When this page is downloaded again using the above URL, however, it should be cached already.

Finally, Web pages can be downloaded by the PTA from the actual Web application used by the user. PTS 30 compares the data from all these tests, and is thus able to determine the source of the problem.

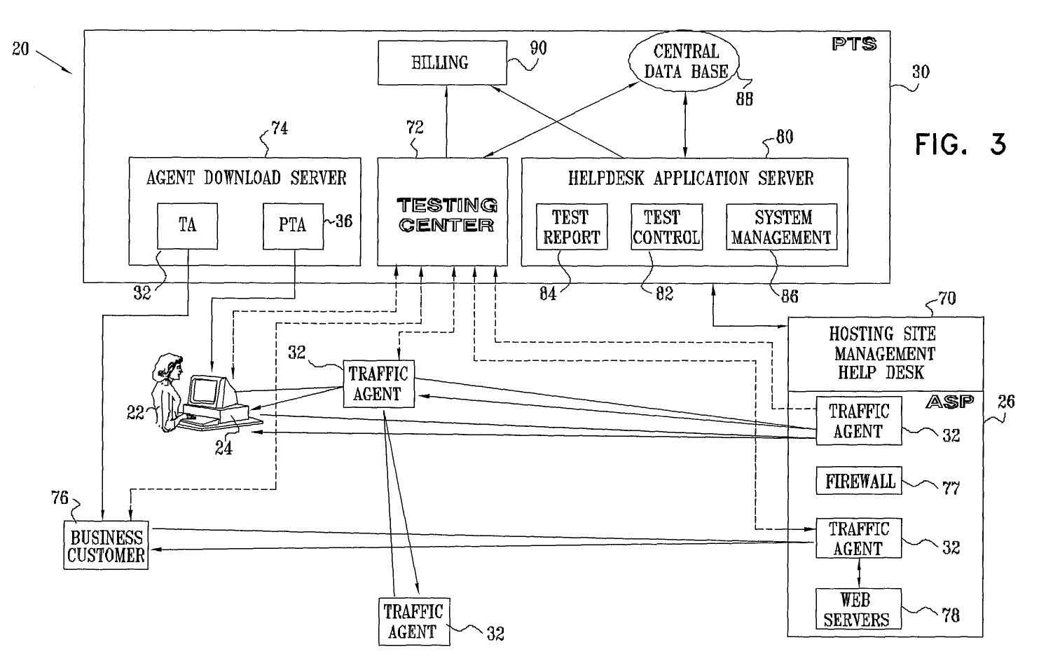

FIG. 3 is a block diagram that schematically shows details of the architecture of system 20, used in carrying out the functions described above, in accordance with a preferred embodiment of the present invention. Dashed arrows in the figure represent communications between a test center server 72 in PTS 30 and traffic agents on network 38 that are involved in carrying out test procedures, including both permanently-installed traffic agents 32 and PTA 36. The solid arrows represent communications of other types. Network 38 is not shown explicitly in this figure for the sake of clarity.

PTS 30 provides diagnostic and troubleshooting services to ASP 26, as well as to other business customers 76. To enable a helpdesk 70 of ASP 26 to access its services conveniently, PTS 30 typically maintains a Web site. To register for the services of PTS 30, ASP 26 follows registration and configuration steps to set up its service. Once the ASP is registered with PTS 30, helpdesk 70 can communicate, preferably via a Web interface, with a helpdesk application server 80 at PTS 30. Server 80 provides a test control function 82, for use by helpdesk 70 in configuring the tests (or test bundles). This function controls the selection, parameters and grouping methods of the tests. It may also be configured with user parameters, including necessary IP addresses and passwords. A test report function 84 issues reports to helpdesk 70, typically via the above-mentioned Web page or by e-mail, as described above. A system management function 86 provides the means to associate particular PTS services with a particular ASP, as well as rules for associating sets of users and business customers with their corresponding ASP.

An agent download server 74 is responsible for downloading traffic agents to hosting sites, including both permanently-installed traffic agents 32 and PTAs 36. Alternatively, software for traffic agents 32 (as opposed to PTAs 36) may be supplied on tangible media, for installation at the hosting sites. Traffic agents are typically permanently installed at business customers 76 of PTS 30, including at ASP 26. In the embodiment shown in FIG. 3, multiple traffic agents are installed at the ASP site, both before a firewall 77 maintained by the ASP, and behind the firewall, typically in association with Web servers 78. The PTS may also maintain dedicated traffic agents 32 that are distributed over the Internet. Such traffic agents may be used as reference sites, to provide test results for comparison against the results obtained by PTA 36 and the traffic agents located at the ASP site. Other reference traffic agents (not shown) may be located behind typical Internet access points of presence (POP), using standard access techniques, such as dialup modems, cable modems and DSL.

PTS 30 maintains a central database 88, which includes records of network topology, with the locations and addresses of all traffic agents, including PTAs 36 running on user computers. These records are used in configuring tests of different types and in processing the test results. Information in the topology database may be made available to ASP 26 via server 80, for use by helpdesk 70 in designating tests and specifying desired reports. Database 88 likewise stores configuration parameters, test bundles, and other records of relevance to testing procedures and reports.

Finally, a billing server 90 receives information from testing center 72 and application server 80 on the use of services of PTS 30 by its customers, such as ASP 26, and charges the customers for these services accordingly.

Software for servers 72, 74, 80 and 90 may be downloaded to PTS 30 in electronic form, over network 38, for example, or it may alternatively be supplied on tangible media, such as CD-ROM. Although these servers are shown, for the sake of clarity, as separate functional blocks, some or all of these functions may be performed together by a single computer. Alternatively, these functions may be further broken down among a group of computers.

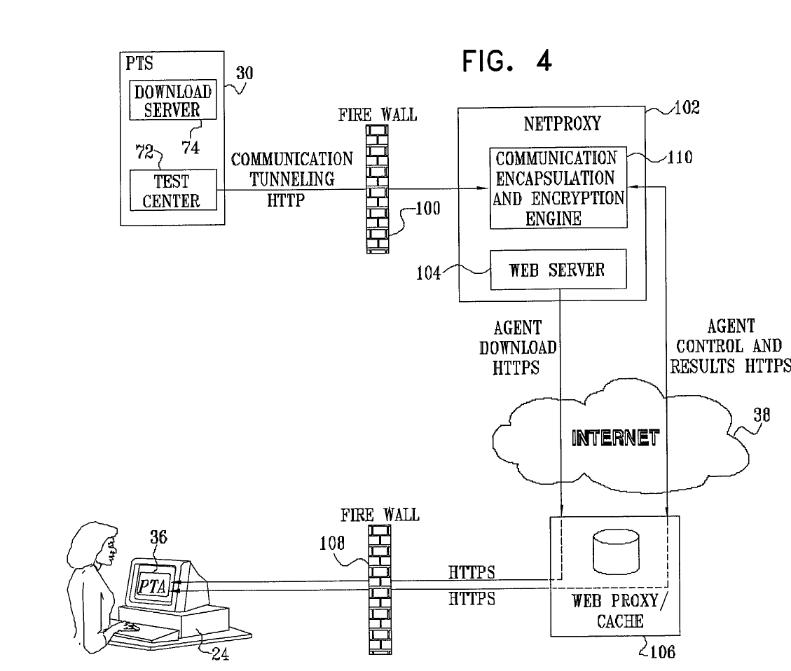

FIG. 4 is a block diagram that schematically illustrates communication between PTS 30 and PTA 36 in the presence of firewalls 100 and 108, in accordance with a preferred embodiment of the present invention. Firewall 100 protects PTS 30, while firewall 108 is maintained by an organization to which user 22 belongs and thus protects computer 24. In this case, PTA 36 is downloaded to computer 24 by a Web server 104, which operates as part of a net proxy server 102 for test center server 72. The HTTPS secure protocol, as is known in the art, is used to convey the PTA to a Web proxy server 106 maintained by the user's organization. Server 106 (which typically also performs cache functions) then passes PTA 36 through firewall 108 by HTTPS to computer 24.

Once PTA 36 is successfully running on computer 24, the PTA communicates with test center server 72 through servers 106 and 102, using HTTPS. Net proxy server 102 also comprises a communication encapsulation and encryption engine 110, which translates between HTTPS messages on communications network 38 and HTTP messages exchanged with server 72. The HTTP messages are sent through firewall 100 by methods of communication tunneling, as are known in the art. Engine 110 thus enables the test center server to control PTA 36 and receive test results from the PTA, as described above.

Although the preferred embodiments described hereinabove relate to solving problems encountered by user 22 in interacting with ASP 26, the methods and systems provided by the present invention are in no way limited to this communication paradigm. Rather, provisional agents and test centers based on the principles of the present invention may be used generally for remote diagnosis of other types of faults and difficulties in user computers and in network communications by such computers. Such communications may include not only Web-based interactions on the Internet, but also communications over networks of other types and using different protocols.

It will thus be appreciated that the preferred embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for network service diagnostics, comprising:
receiving a request from a user of a computer for assistance in an activity performed by the computer;
responsive to the request, downloading an executable program module to the computer over a communication network, which module, when run by the computer, causes the computer to perform a diagnostic operation including sending one or more messages over the network; and
receiving and processing the messages sent by the computer while the computer is running the module, in order to extract diagnostic information from the messages so as to diagnose a problem in the activity performed by the computer.

2. A method according to claim 1, wherein receiving the request comprises receiving a complaint from the user relating to communication over the network, and wherein receiving and processing the messages comprises testing the communication so as to determine a source of the problem.

3. A method according to claim 2, wherein receiving the complaint comprises receiving the complaint at a site operated by a provider of a service over the network, regarding the communication between the user and the site, and wherein testing the communication comprises determining whether the source of the problem is within the site.

4. A method according to claim 3, wherein downloading the executable program module comprises downloading the module from the site operated by the provider of the service to the computer.

5. A method according to claim 3, wherein downloading the executable program module comprises downloading the module from a third-party site to the computer, and wherein receiving and processing the messages comprises receiving the messages at the third-party site, and outputting a report, based on the messages, from the third-party site to the site operated by the provider of the service.

6. A method according to claim 3, wherein determining whether the source of the problem is within the site comprises deploying a plurality of traffic agents on different servers at the site, and receiving at least some of the messages sent by the computer at the different servers in order to localize the problem within the site.

7. A method according to claim 2, wherein receiving the complaint comprises receiving the complaint in connection with a software application that is used in the communication over the network, and wherein testing the communication comprises determining whether the problem is due to the application or to an element of the communication network.

8. A method according to claim 2, wherein the executable program module, when run by the computer, tests an internal function of the computer, and wherein receiving and processing the messages comprises receiving information regarding the internal function and determining, responsive to the information, whether the problem is due to the internal function of the computer.

9. A method according to claim 1, wherein downloading the executable program module comprises downloading software code capable of running on the computer without installation of the module on the computer.

10. A method according to claim 9, wherein the software code is configured to run in conjunction with a browser program on the computer.

11. A method according to claim 10, wherein the software code comprises an applet.

12. A method according to claim 1, wherein receiving and processing the messages comprises receiving one or more of the messages at a traffic agent connected to the network, and informing a test center regarding receipt of the messages.

13. A method according to claim 1, and comprising transmitting a further message from a traffic agent connected to the network to the computer while the computer is running the module, and informing a test center regarding receipt of the messages by the computer.

14. A method according to claim 1, wherein receiving and processing the messages comprises receiving one or more of the messages at a test center, wherein the one or more of the messages contain a report of the diagnostic operation performed by the computer.

15. A method for computer diagnostics, comprising:
receiving a request from a user of a computer to a helpdesk operated by a supplier of a network service, for assistance in solving a problem encountered by the user in operation of the service;
reporting the request from the helpdesk to a test center;
responsive to the request, downloading an executable program module from the test center to the computer over a communication network, which module, when run by the computer, causes the computer to perform diagnostic operations including communicating over the network; and
exchanging messages between the test center and the computer while the computer is running the module, so as to select the diagnostic operations to be performed by the computer and to receive information from the computer regarding a result of the operations;
responsive to the information received from the computer, providing a report from the test center to the helpdesk indicative of a source of the problem.

16. A method according to claim 15, wherein downloading the executable program module comprises downloading software code capable of running on the computer without installation of the module on the computer.

17. A method according to claim 16, wherein the software code is configured to run in conjunction with a browser program on the computer.

18. A method according to claim 17, wherein the software code comprises an applet.

19. A method according to claim 17, wherein exchanging the messages comprises exchanging the messages in accordance with a Hypertext Transfer Protocol (HTTP), such that the test center acts as a HTTP server, while the computer acts as a HTTP client.

20. Apparatus for computer diagnostics, comprising a test server, which is adapted to receive a report of a request from a user of a computer for assistance in an activity performed by the computer and, responsive to the request, to cause an executable program module to be downloaded to the computer over a communication network, which module, when run by the computer, causes the computer to perform a diagnostic operation including sending one or more messages over the network, and which is further adapted to receive and process at least some of the messages sent by the computer while the computer is running the module, in order to diagnose a problem in the activity performed by the computer.

21. Apparatus according to claim 20, wherein the request comprises a complaint from the user relating to communication over the network, and wherein the server is adapted to test the communication, using the messages sent by the computer, so as to determine a source of the problem.

22. Apparatus according to claim 21, wherein the complaint is received at a site operated by a provider of a service over the network, regarding the communication between the user and the site, and wherein the server is adapted to determine whether the source of the problem is within the site.

23. Apparatus according to claim 22, wherein the executable program module is downloaded from the site operated by the provider of the service to the computer.

24. Apparatus according to claim 22, wherein the server is located at a third-party site, from which the module is downloaded to the computer, and wherein the server is adapted to output a report, based on the messages, from the third-party site to the site operated by the provider of the service.

25. Apparatus according to claim 22, wherein a plurality of traffic agents are deployed on different nodes at the site, and wherein the server is adapted to direct the computer to send at least some of the messages to the different nodes in order to localize the problem within the site.

26. Apparatus according to claim 21, wherein the complaint is related to a software application that is used in the communication over the network, and wherein the server is adapted to determine whether the problem is due to the application or to an element of the communication network.

27. Apparatus according to claim 21, wherein the executable program module, when run by the computer, tests an internal function of the computer, and wherein one or more of the messages contain information regarding the internal function, and wherein the server is adapted to determine, responsive to the information, whether the problem is due to the internal function of the computer.

28. Apparatus according to claim 20, wherein the executable program module comprises software code capable of running on the computer without installation of the module on the computer.

29. Apparatus according to claim 28, wherein the software code is configured to run in conjunction with a browser program on the computer.

30. Apparatus according to claim 29, wherein the software code comprises an applet.

31. Apparatus according to claim 20, wherein the server is adapted to direct the computer to send one or more of the messages to a traffic agent connected to the network, and to receive information from the traffic agent regarding receipt of the messages.

32. Apparatus according to claim 20, wherein the server is adapted to direct a traffic agent connected to the network to send one or more of the messages to the computer, and to receive information from the computer regarding receipt of the messages.

33. Apparatus according to claim 20, wherein one or more of the messages sent by the computer contain a report from the computer to the server of the diagnostic operation performed by the computer.

34. Apparatus for computer diagnostics, comprising:
a helpdesk server, which is adapted to receive an indication from a helpdesk operated by a supplier of a network service of a request from a user of a computer for assistance in solving a problem encountered by the user in operation of the service;
a test agent download server, which is adapted, responsive to the request, to download an executable program module to the computer over a communication network, which module, when run by the computer, causes the computer to perform diagnostic operations including communicating over the network; and
a test server, which is adapted to exchange messages with the computer while the computer is running the module, so as to select the diagnostic operations to be performed by the computer and to receive information from the computer regarding a result of the operations,
wherein responsive to the information received from the computer, the helpdesk server provides a report to the helpdesk indicative of a source of the problem.

35. Apparatus according to claim 34, wherein the executable program module comprises software code capable of running on the computer without installation of the module on the computer.

36. Apparatus according to claim 35, wherein the software code is configured to run in conjunction with a browser program on the computer.

37. Apparatus according to claim 36, wherein the software code comprises an applet.

38. Apparatus according to claim 35, wherein the test server is adapted to exchange the messages with the computer in accordance with a Hypertext Transfer Protocol (HTTP), such that the test center acts as a HTTP server, while the computer acts as a HTTP client.

39. A computer software product, comprising a computer-readable medium in which program instructions are stored, which instructions, when read by a computer server, cause the server, responsive to receiving a report of a request from a user of a client computer for assistance in an activity performed by the client computer, to cause an executable program module to be downloaded to the client computer over a communication network, which module, when run by the client computer, causes the client computer to perform a diagnostic operation including sending one or more messages over the network, the instructions further causing the server to receive and process at least some of the messages sent by the client computer while the client computer is running the module, in order to diagnose a problem in the activity performed by the client computer.

40. A product according to claim 39, wherein the request comprises a complaint from the user relating to communication over the network, and wherein the instructions cause the server to test the communication, using the messages sent by the client computer, so as to determine a source of the problem.

41. A product according to claim 40, wherein the complaint is received at a site operated by a provider of a service over the network, regarding the communication between the user and the site, and wherein the instructions cause the server to determine whether the source of the problem is within the site.

42. A product according to claim 41, wherein the executable program module is downloaded from the site operated by the provider of the service to the client computer.

43. A product according to claim 41, wherein server is located at a third-party site, from which the module is downloaded to the client computer, and wherein the instructions cause the server to output a report, based on the messages, from the third-party site to the site operated by the provider of the service.

44. A product according to claim 41, wherein a plurality of traffic agents are deployed on different nodes at the site, and wherein the instructions cause the server to direct the client computer to send at least some of the messages to the different nodes in order to localize the problem within the site.

45. A product according to claim 40, wherein the complaint is related to a software application that is used in the communication over the network, and wherein the instructions cause the server to determine whether the problem is due to the application or to an element of the communication network.

46. A product according to claim 40, wherein the executable program module, when run by the client computer, tests an internal function of the client computer, and wherein one or more of the messages contain information regarding the internal function, and wherein the instructions cause the server to determine, responsive to the information, whether the problem is due to the internal function of the client computer.

47. A product according to claim 39, wherein the executable program module comprises software code capable of running on the client computer without installation of the module on the client computer.

48. A product according to claim 47, wherein the software code is configured to run in conjunction with a browser program on the client computer.

49. A product according to claim 48, wherein the software code comprises an applet.

50. A product according to claim 39, wherein the instructions cause the server to direct the client computer to send one or more of the messages to a traffic agent connected to the network, and to receive information from the traffic agent regarding receipt of the messages.

51. A product according to claim 39, wherein the instructions cause the server to direct a traffic agent connected to the network to send one or more of the messages to the client computer, and to receive information from the client computer regarding receipt of the messages.

52. A product according to claim 39, wherein one or more of the messages sent by the client computer contain a report from the client computer to the server of the diagnostic operation performed by the computer.

53. A computer software product, comprising a computer-readable medium in which program instructions are stored, which instructions, when read by a set of one of more computer servers, cause the servers to receive an indication, from a helpdesk operated by a supplier of a network service, of a request from a user of a client computer for assistance in solving a problem encountered by the user in operation of the service, and further cause the servers, responsive to the request, to download an executable program module to the client computer over a communication network, which module, when run by the client computer, causes the computer to perform diagnostic operations including communicating over the network, and further cause the servers to exchange messages with the client computer while the client computer is running the module, so as to select the diagnostic operations to be performed by the client computer and to receive information from the client computer regarding a result of the operations, and responsive to the information received from the client computer, to provide a report to the helpdesk indicative of a source of the problem.

54. A product according to claim 53, wherein the executable program module comprises software code capable of running on the client computer without installation of the module on the computer.

55. A product according to claim 54, wherein the software code is configured to run in conjunction with a browser program on the computer.

56. A product according to claim 55, wherein the software code comprises an applet.

57. A product according to claim 55, wherein the instructions cause the servers to exchange the messages with the client computer in accordance with a Hypertext Transfer Protocol (HTTP), such that the servers act as a HTTP server, while the client computer acts as a HTTP client.
